(19) United States
(12) Patent Application Publication
(10) Pub. No.: US 2025/0058553 A1
(43) Pub. Date: Feb. 20, 2025

(54) ARTICLE COMPRISING A LAYER WITH DISPERSED GLASS FIBERS AND A LAYER WITH CONTINUOUS GLASS FIBERS

(71) Applicant: SABIC GLOBAL TECHNOLOGIES B.V., Bergen op Zoom (NL)

(72) Inventors: Xiqiang Liu, Shanghai (CN); Christelle Marie Helene Grein, Aachen (DE); Chaodong Jiang, Shanghai (CN); Liang Wen, Shanghai (CN); Hailun Wang, Shanghai (CN)

(21) Appl. No.: 18/721,030

(22) PCT Filed: Dec. 13, 2022
(86) PCT No.: PCT/EP2022/085733

§ 371 Date: Jun. 17, 2024

(30) Foreign Application Priority Data
Dec. 17, 2021 (WO) PCT/CN2021/139184

(51) Int. Cl. B32B 27/32; B32B 27/20

(52) U.S. Cl. CPC B32B 27/32; B32B 27/20; B32B 2250/03; B32B 2260/023; B32B 2260/046; B32B 2262/101; B32B 2307/3065; B32B 2323/10

(57) ABSTRACT

The present invention relates to an article comprising a layer with dispersed glass fibers and a layer with continuous glass fibers. The article according to the invention has superior stiffness and is suitable to be molded with mold of complex geometry. e.g. battery case in a vehicle. It is further preferred that the article is fire resistant.

### CROSS REFERENCE TO RELATED APPLICATIONS

This application is a National Stage application of PCT/EP2022/085733 filed Dec. 13, 2022, which claims the benefit of PCT/CN2021/139184 filed Dec. 17, 2021, both of which are incorporated by reference in their entirety herein.

### BACKGROUND

The present invention relates to an article comprising a layer with dispersed glass fibers and a layer with continuous glass fibers, the present invention further relates to a process for the preparation of such article.

Polypropylene comprising dispersed glass fiber is well known in the art and widely uses in automotive industry, for instance WO 2018/019762 discloses a glass fiber reinforced polypropylene composition, however it was found that this type of composition lacks stiffness; unidirectional (UD) tape based on polypropylene is also known in the art and widely use thanks to its superior stiffness, however the high stiffness also makes UD tapes difficult to be used in an article with complex geometry, e.g. battery case in a vehicle.

### SUMMARY

It is therefore the purpose of the present invention to provide an article with superior stiffness and suitable to be molded with mold of complex geometry, e.g. battery case in a vehicle. It is further preferred that the article is fire resistant.

Accordingly, the present invention provides an article comprising a first layer and a second layer,
wherein the first layer comprises a first polypropylene composition comprising a first polypropylene and dispersed glass fibers (A), wherein the dispersed glass fibers (A) have an average length in the range from 0.3 to 6.3 mm, wherein the amount of the dispersed glass fiber (A) is in the range from 14.7 to 67.2 wt % based on the total amount of the first polypropylene composition,
wherein the second layer comprise a second polypropylene composition comprising a second polypropylene and continuous glass fibers, wherein the continuous glass fibers are substantially parallel with each other, wherein the amount of the continuous glass fibers in the second polypropylene composition is in the range from 18.8 to 63.4 wt % based on the total amount of the second polypropylene composition.

### DETAILED DESCRIPTION

In the context of the present invention, a “layer” is to be understood as an object in the form of a sheet.

### First Layer

The first layer comprises a first polypropylene composition. Preferably the amount of the first polypropylene composition is at least 80 wt %, preferably at least 90 wt %, more preferably at least 95 wt %, most preferably 100 wt % based on the total amount of the first layer.

The first polypropylene composition is usually provided in the form of pellets, the first layer can for example be obtained by injection molding or extrusion molding the first polypropylene composition.

The first polypropylene composition comprises a first polypropylene, dispersed glass fibers (A) and preferably a first flame retardant composition.

The amount of the first polypropylene in the first polypropylene composition is preferably in the range from 25 to 65 wt %, more preferably from 29 to 55 wt %, even more preferably in the range from 31 to 48 wt % based on the total amount of the first polypropylene composition.

The amount of the dispersed glass fibers (A) is in the range from 14.7 to 67.2 wt %, preferably from 16.2 to 53.0 wt %, more preferably from 18.2 to 36.5 wt % based on the total amount of the first polypropylene composition.

The amount of the first flame retardant composition is preferably in the range from 13.2 to 43.1 wt %, preferably in the range from 17.6 to 34.3 wt % based on the total amount of the first polypropylene composition.

Optionally, the first polypropylene composition further comprises at most 5 wt % additives, for example: Processing aid, anti oxidant, nucleating agent, acid scavenger, UV stabilizer, heat stabilizer, etc.

The first polypropylene composition can be prepared by known method, for instance, the so called wire coating process as described in WO2009080281, especially in the embodiments that the flame retardant composition is present WO2020234024 which are used as reference in the present applications. Alternatively, the first polypropylene composition can be prepared by conventional compounding process wherein the first polypropylene, dispersed glass fibers (A), the preferred first flame retardant composition and optional additives are mixed in an extruder.

Preferably the first layer has a UL 94 rating of V0.

### Second Layer

The second layer comprises a second polypropylene composition. Preferably the amount of the second polypropylene composition is at least 80 wt %, preferably at least 90 wt %, more preferably at least 95 wt %, most preferably 100 wt % based on the total amount of the second layer.

The second layer is often referred as unidirectional tape or unidirectional composition in the art. It can be prepared in know method, e.g. as described in WO2016142786A1, EP3368297B1, EP0530450A1, U.S. Pat. No. 5,496,602A, WO2019122318 and WO2020229410 which are used as reference.

The second polypropylene composition comprises a second polypropylene, continuous glass fibers and preferably a second flame retardant composition.

The amount of the second polypropylene in the second polypropylene composition is preferably in the range from 20 to 53 wt %, more preferably from 22 to 42 wt %, even more preferably in the range from 24 to 38 wt % based on the total amount of the second polypropylene composition.

The continuous glass fibers in the second layer are substantially parallel with each other. Preferably the continuous glass fibers are arranged in at least one plane. Preferably the continuous glass fibers are arranged in at most three planes, preferably in at least two planes. A higher number of planes of glass fibers could lead to too high rigidity of the article and leads to a low fidelity to the mold during molding. Preferably the distance between the adjacent continuous glass fibers in one plane is substantially the same. The continuous glass fibers preferably have a diameter in the range from 5 to 50 μm, more preferably from 10 to 30 μm, even more preferably from 15 to 25 μm.

Preferably the continuous glass fibers extends from one side to another side of the second layer without breakage.

The second layer has an area density in the range from 1125 to 5600 g/m2, preferably from 1234 to 4465, more preferably in the range from 1348 to 3323, most preferably from 1444 to 2289 g/m2. The area density can be measure by cutting a 1 m2 of a layer and having its weight measured.

The amount of the continuous glass fibers is in the range from 18.8 to 63.4 wt %, preferably from 29.2 to 56.0 wt %, more preferably from 42.2 to 51.5 wt % based on the total amount of the second polypropylene composition.

The amount of the second flame retardant composition is preferably in the range from 12.2 to 32.1 wt %, preferably in the range from 16.6 to 25.3 wt % based on the total amount of the second polypropylene composition.

Optionally, the second polypropylene composition further comprises at most 5 wt % additives, for example: Processing aid, anti oxidant, nucleating agent, acid scavenger, UV stabilizer, heat stabilizer, etc.

Preferably the second layer has a UL 94 rating of V0.

Preferably the first and the second layer has a UL 94 rating of V0.

### Third Layer

The third layer comprises a third polypropylene composition. Preferably the amount of the third polypropylene composition is at least 80 wt %, preferably at least 90 wt %, more preferably at least 95 wt %, most preferably 100 wt % based on the total amount of the third layer.

The third polypropylene composition is usually provided in the form of pellets, the third layer can for example be obtained by injection molding or extrusion molding the third polypropylene composition.

The third polypropylene composition comprises a third polypropylene, dispersed glass fibers (B) and preferably a third flame retardant composition.

The amount of the third polypropylene in the third polypropylene composition is preferably in the range from 25 to 65 wt %, more preferably from 29 to 55 wt %, even more preferably in the range from 31 to 48 wt % based on the total amount of the third polypropylene composition.

The amount of the dispersed glass fibers (B) is in the range from 14.7 to 67.2 wt %, preferably from 16.2 to 53.0 wt %, more preferably from 18.2 to 36.5 wt % based on the total amount of the third polypropylene composition.

The amount of the third flame retardant composition is preferably in the range from 13.2 to 43.1 wt %, preferably in the range from 17.6 to 34.3 wt % based on the total amount of the third polypropylene composition.

Preferably the third layer has a UL 94 rating of V0.

Preferably the first, the second and the third layer have a UL 94 rating of V0.

Optionally, the third polypropylene composition further comprises at most 5 wt % additives, for example: Processing aid, anti oxidant, nucleating agent, acid scavenger, UV stabilizer, heat stabilizer, etc.

The third polypropylene composition can be prepared by known method, for instance, the so called wire coating process as described in WO2009080281 which is used as reference in the present applications. Alternatively, the third polypropylene composition can be prepared by conventional compounding process wherein the third polypropylene, dispersed glass fibers (B), the preferred third flame retardant composition and optional additives are mixed in an extruder.

Preferably the third polypropylene composition is identical to the first polypropylene composition and the third layer is identical to the first layer.

### Dispersed Glass Fiber (A) and Dispersed Glass Fiber (B)

The first polypropylene composition comprises dispersed glass fiber (A), the third polypropylene composition comprises dispersed glass fiber (B). The description of dispersed glass fiber applies to both dispersed glass fiber (A) and dispersed glass fiber (B). In a preferred embodiment, dispersed glass fiber (A) is identical to dispersed glass fiber (B)

The dispersed fibers have an average length in the range from 0.3 to 6.3 mm, preferably from 0.5 to 5.8 mm, preferably in the range from 1.4 to 5.5 mm, more preferably in the range from 2.5 to 5.4 mm. The length of the dispersed fibers reduce during the preparation of the first and third polypropylene composition and/or the preparation of the first and third layer, in avoidance of any confusion, the length of the dispersed glass fibers in the present invention refers to the length of the dispersed glass fibers in the first and third layer.

The average length of the dispersed fibers can for example be obtained by incinerating the first layer or the third layer, then the fibers are manually dispersed on a scanner using brushes and tweezers and a digital image is generated, a fully automated image processing algorithm detects all fibers without manual input by the operator. 350,000 to 750,000 fiber length are detected to calculate the average fiber length; if flame retardant composition is present, cinder can not be obtained by incinerating the first or the third layer, in this embodiment, for example a micro-CT technique could be employed to create a 3D image of the internal structure of the first or the third layer, an image processing algorithm could be used to process the 3D image to obtain the average glass fiber length.

Usually the dispersed glass fibers are circular in cross section. Preferably the dispersed glass fibers have a diameter in the range from 5 to 50 μm, more preferably from 10 to 30 μm, even more preferably from 15 to 25 μm.

In a preferred embodiment, the dispersed glass fiber comprises at most 2 wt %, preferably in the range from 0.10 to 1 wt % of a sizing based on the dispersed glass fiber. The amount of sizing can be determined using ISO 1887:2014.

Suitable examples of sizing compositions include solvent-based compositions, such as an organic material dissolved in aqueous solutions or dispersed in water and melt- or radiation cure-based compositions. Preferably, the sizing composition is an aqueous sizing composition.

As described in the art, e.g. in documents EP1460166A1, EP0206189A1 or U.S. Pat. No. 4,338,233, the aqueous sizing composition may include coupling agents and other additional components.

The coupling agents are generally used to improve the adhesion between the matrix thermoplastic polymer and the fibre reinforcements. Suitable examples of coupling agents known in the art as being used for the glass fibres include organofunctional silanes. More particularly, the coupling agent which has been added to the sizing composition is an aminosilane, such as aminomethyl-trimethoxysilane, N-(beta-aminoethyl)-gamma-aminopropyl-trimethoxysilane, gamma-aminopropyl-trimethoxysilane gamma-methylaminopropyl-trimethoxysilane, delta-aminobutyl-triethoxysilane, 1,4-aminophenyl-trimethoxysilane. Preferably, the sizing composition contains an aminosilane to enable a good adhesion to the thermoplastic matrix. The sizing composition may further comprise any other additional components known to the person skilled in the art to be suitable for sizing compositions. Suitable examples include but are not limited to lubricants (used to prevent damage to the strands by abrasion) antistatic agents, crosslinking agents, plasticizers, surfactants, nucleation agents, antioxidants, pigments as well as mixtures thereof.

### The First Polypropylene, the Second Polypropylene and the Third Polypropylene

The description on polypropylene applies to all three first, second and third polypropylene. Preferably the first polypropylene is identical to the third polypropylene.

Preferably the polypropylene has an MFI in the range from 23 to 85 g/10 min, preferably from 33 to 78 g/10 min, more preferably from 37 to 74 g/10 min as measure according to ISO1133 at 230° C., 2.16 kg.

Preferably the polypropylene is a propylene homopolymer or a heterophasic propylene copolymer. A propylene homopolymer could provide a higher stiffness while a heterophasic propylene copolymer could provide a higher toughness. Preferably the heterophasic propylene copolymer consists of a propylene homopolymer matrix and an ethylene-propylene copolymer as dispersed phase, wherein preferably the amount of the ethylene-propylene copolymer is in the range from 12 to 22 wt %, more preferably in the range from 13 to 18 wt % based on the total amount of the heterophasic propylene copolymer, the amount of the ethylene-propylene copolymer can for example be determined by ¹³C-NMR, as well known in the art.

The polypropylene can be produced in known process, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524.

### The First Flame Retardant Composition, the Second Flame Retardant Composition and the Third Flame Retardant Composition

The description of the flame retardant composition applies to all three the first flame retardant composition, the second flame retardant composition and the third flame retardant composition.

The flame retardant composition may be a halogen-free flame retardant composition or a halogenated flame retardant composition.

### Halogen-Free Flame Retardant Composition

The halogen-free flame retardant composition preferably comprises an organophosphorus compound.

Preferably, the organophosphorus compound is selected from the group consisting of melamine phosphate, melamine polyphosphate, melamine pyrophosphate, piperazine phosphate, piperazine polyphosphate, piperazine pyrophosphate, 2-methylpiperazine monophosphate, tricresyl phosphate, alkyl phosphates, tetraphenyl pyrophosphate, poly(2-hydroxy propylene spirocyclic pentaerythritol bisphosphate) and poly(2,2-dimethylpropylene spirocyclic pentaerythritol bisphosphonate) and combinations thereof.

More preferably, the organophosphorus compound is selected from the group consisting of melamine phosphate, melamine polyphosphate, melamine pyrophosphate, piperazine phosphate, piperazine polyphosphate, piperazine pyrophosphate and 2-methylpiperazine monophosphate and combinations thereof.

In some embodiments, the organophosphorus compound comprises a first compound selected from melamine phosphate, melamine polyphosphate and melamine pyrophosphate a second compound selected from piperazine phosphate, piperazine polyphosphate, piperazine pyrophosphate and 2-methylpiperazine monophosphate.

The weight ratio between the first compound and the second compound may e.g. be 1:5 to 5:1, for example 1:5 to 1:1 or 1:1 to 5:1.

The halogen-free flame retardant composition may further comprise zinc oxide and/or ammonium polyphosphate.

Preferably, the amount of zinc oxide in the halogen-free flame retardant composition with respect to the total amount of the organophosphorus compound, zinc oxide and ammonium polyphosphate is 1.0 to 10 wt %.

The halogen-free flame retardant composition may further comprise ammonium polyphosphate.

Preferably, the amount of ammonium polyphosphate in the halogen-free flame retardant composition with respect to the total amount of the organophosphorus compound, zinc oxide and ammonium polyphosphate is 5.0 to 15 wt %.

In some embodiments, the halogen-free flame retardant composition comprises particles comprising
a first compound selected from melamine phosphate, melamine polyphosphate and melamine pyrophosphate,
a second compound selected from piperazine phosphate, piperazine polyphosphate, piperazine pyrophosphate and 2-methylpiperazine monophosphate,
zinc oxide and
ammonium polyphosphate,
wherein
the amount of the first compound, for example melamine phosphate, is 50 to 80 wt %,
the amount of the second compound, for example piperazine phosphate, is 10 to 25 wt % and
the amount of zinc oxide is 1.0 to 10 wt %,
the amount of the ammonium polyphosphate is 5.0 to 15 wt %,
with respect to the particles.

Preferably, the amount of the particles with respect to the total composition is 15 to 40 wt %.

In some embodiments, the halogen-free flame retardant composition further comprises an aromatic phosphate ester. Preferably, the amount of the aromatic phosphate ester flame retardant is 0.1 to 15 wt % with respect to the total composition.

Preferably, the aromatic phosphate ester is selected from the group consisting of resorcinol bis(diphenyl phosphate); tetraphenyl resorcinol bis(diphenylphosphate); bisphenol A bis(diphenyl phosphate); bisphenol A diphosphate; resorcinol bis(di-2,6-xylyl phosphate), phosphoric acid, mixed esters with [1,1′-biphenyl]-4-4′-diol and phenol; phosphorictrichloride, polymer with 1,3-benzenediol, phenylester; 1,3-phenylene-tetrakis(2,6-dimethylphenyl)diphosphate; isopropenylphenyl diphenyl phosphate; 4-phenylphenolformaldehyde phenylphosphonate; tris(2,6-xylyl) phosphate; resorcinol bis(di-2,6-xylyl phosphate); bisphenol S bis(diphenyl phosphate); resorcinol-bisphenol A phenyl phosphates.

Preferably, the aromatic phosphate ester is added as a liquid.

Preferably, the aromatic phosphate ester is bisphenol A bis(diphenyl phosphate).

Adeka FP2500 is for example a halogen-free flame retardant composition according to the invention.

### Halogenated Flame Retardant Composition

Preferably, the halogenated flame retardant composition comprises a brominated flame retardant.

Suitable examples include tetrabromobisphenol A derivatives, including bis(2-hydroxyethyl) ether of tetrabromobisphenol A, bis(3-acryloyloxy-2-hydroxypropyl) ether of tetrabromobisphenol A, bis(3-methacryloyloxy-2-hydroxypropyl) ether of tetrabromobisphenol A, bis(3-hydroxypropyl) ether of tetrabromobisphenol A, bis(2,3-dibromopropyl) ether of tetrabromobisphenol A, diallyl ether of tetrabromobisphenol A, and bis(vinylbenzyl) ether of tetrabromobisphenol A; brominated polycarbonates, tetrabromobisphenol A polycarbonate oligomer, brominated polyacrylate such as polypentabromobenzyl acrylate; brominated polystyrenes, such as polydibromostyrenes and polytribromostyrenes; brominated BPA polyepoxides, tetrabromocyclooctanes; dibromoethyldibromocyclohexanes such as 1,2-dibromo-4-(1,2-dibromoethyl)-cyclohexane; ethylene-bis-tetrabromophthalimide; hexabromocyclododecanes; tetrabromophthalic anhydrides; brominated diphenylethers such as decabromodiphenyl ether; poly(2,6-dibromophenylene ether); tris(2,4,6-tribromophenoxy-1,3,5-triazine; tris(tribromoneopentyl)phosphate; and decabromodiphenyl ethane. Particularly preferred examples include bis(2,3-dibromopropyl) ether of tetrabromobisphenol A (commercially available as FR-720 from ICL Industrial products) and polypentabromobenzyl acrylate (commercially available as FR-1025 from ICL Industrial products), tris(tribromoneopentyl)phosphate (commercially available as FR-370 from ICL Industrial products), decabromodiphenyl ether (commercially available as FR-1210 from ICL Industrial products) and decabromodiphenyl ethane (commercially available as FR-1410 from ICL Industrial products).

Most preferred is bis(2,3-dibromopropyl) ether of tetrabromobisphenol A.

In the present invention, the halogen-free flame retardant composition is preferred over the halogenated flame retardant composition.

### The Article

The article according to the present invention comprises the first layer, the second layer and preferably the third layer. Preferably the article comprises the first layer, the second layer and the third layer wherein the second layer is between the first layer and the third layer.

In a preferred embodiment, the article consists of the first layer, the second layer and the third layer wherein the second layer is between the first layer and the third layer.

For the purpose of the present invention it is preferred the article has a flexural modulus of at least 8000 MPa as determined by ISO178/1A at 23° C.

The article is usually in the form of a laminate.

The present invention further relates to a process for the preparation of an article according to the invention comprising the sequential steps:
Providing the first layer, the second layer and preferably the third layer;
Thermoforming the first layer, the second layer and the preferred third layer, wherein the second layer is placed between the first layer and the third layer.

It should be noted that the thickness of the first, the second and the third layers may vary during the thermoforming, for example the first, the second and the third layer has a higher total thickness prior to thermoforming than after thermoforming. The reason behind this variation of thickness if the overflow of polypropylene compositions during the thermoforming. In the context of the present invention, the second polypropylene composition typically has a low thickness and has poor flowability during the thermoforming, so the thickness of the second layer typically does not vary during the thermoforming; the first and the third polypropylene composition typically have a higher thickness and have better flowability during the thermoforming, so the thickness of the first and the third layer typically reduces during the thermoforming.

Preferably the first layer has a thickness in the range from 0.8 to 2.7 mm, preferably in the range from 1.1 to 2.2 mm, more preferably in the range from 1.2 to 1.8 mm prior to thermoforming; preferably the third layer has a thickness in the range from 0.8 to 2.7 mm, preferably in the range from 1.1 to 2.2 mm, more preferably in the range from 1.2 to 1.8 mm prior to thermoforming; preferably the second layer has a thickness in the range from 0.3 to 3.2 mm, more preferably in the range from 0.3 to 2.4 mm, even more preferably in the range from 0.3 to 1.8 mm, most preferably in the range from 0.3 to 1.2 mm prior to thermoforming.

The thickness of the first layer is preferably in the range from 0.6 to 2.4 mm, more preferably in the range from 0.7 to 2.1 mm, more preferably in the range from 0.8 to 1.8 mm, most preferably in the range from 0.8 to 1.5 mm in the article; The thickness of the third layer is preferably in the range from 0.6 to 2.4 mm, more preferably in the range from 0.7 to 2.1 mm, more preferably in the range from 0.8 to 1.8 mm, most preferably in the range from 0.8 to 1.5 mm in the article; preferably the second layer has a thickness in the range from 0.3 to 3.2 mm, more preferably in the range from 0.3 to 2.4 mm, even more preferably in the range from 0.3 to 1.8 mm, most preferably in the range from 0.3 to 1.2 mm in the article.

The thickness of the first, the second and the third layer in the article is the thickness of the first, the second and the third layer after thermoforming.

The article according to the invention preferably has a thickness in the range from 1.2 mm to 6.0 mm, preferably from 1.5 to 4.8 mm, more preferably from 1.8 to 3.6 mm, even more preferably from 2.1 to 3.0 mm. The article having a thickness in the preferred range has optimal balance between the weight and mechanical and flame retardant performance.

The article according to the invention is preferably part of a battery enclosure in a vehicle.

### Experiment

### Material

M1: Long glass fiber reinforced polypropylene SABIC® STAMAX 30YH515, it comprises 30 wt % long glass fiber.

M2: Short glass fiber reinforced polypropylene SABIC® PPCOMPOUND H1030, it comprises 30 wt % short glass fiber.

CS1: CFERTPlus GPP50FR 2X U340 from Qiyi Technology. It is a unidirectional tape comprising two sub-layers, each sub-layer comprises continues glass fibers wherein the continues glass fibers are substantially parallel with each other in one plane, wherein the distance between the adjacent continuous glass fibers in one plane is substantially the same, wherein the planes in the two sub-layers are substantially parallel with each other, wherein the glass fibers in one plane are substantially parallel with the glass fibers in the other plane. The amount of continues glass fibers in CS1 is 50 wt %. CS1 has a UL-94 rating of V0. CS1 has a thickness of 0.6 mm, and an area density of 1656 g/m2.

### Sample Preparation

ES1 was obtained by extruding M1 in a single screw extruder, the average fiber length of ES1 is 5.0 mm;
ES2 was obtained by extruding M1 in a single screw extruder the average fiber length of ES2 is 1.2 mm;
MS1 was obtained by injection molding M1 the average fiber length of MS1 is 2.0 mm;
MS2 was obtained by injection molding M2 the average fiber length of MS1 is 1.0 mm.

The average fiber length is obtained by scanning ES1, ES2, MS1 and MS2 with a micro-CT to create a 3D image of the internal structure of S1, ES2, MS1 and MS2, an image processing algorithm was used to process the 3D image to obtain the average glass fiber length based on all the glass fiber identified by the algorithm.

ES1, ES2, MS1, MS2 have the same dimension of 200*200*1.5 mm and have a UL-94 rating of V0 at 1.5 mm.

Then ES1, ES2, MS1 and MS2 were co-thermoformed with CS1, for the preparation of EX1 to 11. The dimensions and layout of examples are in Table 1:

TABLE 1
Layout of Examples

| | Dimensions (mm) | Layer 1 | Layer 2 | Layer 3 |
|---|---|---|---|---|
| EX1 | 200*200*2.5 | CS1 | ES1 | ES1 |
| EX2 | 200*200*2.5 | CS1 | ES1 | CS1 |
| EX3 | 200*200*2.5 | ES1 | CS1 | ES1 |
| EX4 | 200*200*2.5 | ES2 | CS1 | ES2 |
| EX5 | 200*200*2.5 | CS1 | MS1 | MS1 |
| EX6 | 200*200*2.5 | CS1 | MS1 | CS1 |
| EX7 | 200*200*2.5 | MS1 | CS1 | MS1 |
| EX8 | 200*200*2.5 | MS2 | CS1 | MS2 |

| | | |
|---|---|---|
| EX9 | 200*200*2.5 | M1* |
| EX10 | 200*200*2.5 | M2* |
| EX11 | 200*200*2.5 | CS1** |

*EX9 and 10 are extruded M1 and M2 into a sheet with a thickness of 2.5 mm
**EX11 is obtained by thermoforming five layer of EX11

### Measurement Methods

Mechanical measurements: EX1 to 11 were cut into 4*80*2.5 mm specimens. Flexural modulus was determined by ISO178/1A, impact resistance was determined by ISO179-1:2010 at 23° C., HDT was determined by ISO75.

Flame retardant checking: Whole plaque (200*200*2.5 mm) of EX1 to 11 were used directly. The measurement was carried out following the sequential steps of:
Placing the Examples on a horizontal frame made by metallic wire, the frame has a dimension of 195*195 mm;
Placing a flame source at 2.5 cm below geometrical center of the Examples;
Igniting the flame source and the outer flame has a temperature of 1000° C., the outer flame is in direct contact with the Examples;
Keeping the Examples' exposure to the outer flame for 5 min;
Stopping the Examples' exposure to the flame;
Recording if the time for the flame on Examples to extinguish is longer than 2 min;
Observing whether the flame burnt through the Examples.

The if an Example was not burnt through by the flame and the ignited part of the Example extinguished in 2 min after the flame was removed, the Example was rated as pass; otherwise the rating would be fail.

Fidelity to the mold during shaping: Examples were cut into 1.8m*0.9m*2.5 mm and molded into a half of an EV battery enclosure by thermoforming. The mold has a square grid pattern: The thickness of the rib of grid is 2 mm, the height of rib is 1 cm, the square has a form of 6 cm*6 cm. After molding, the Examples were inspected visually with the following rating:
1: Mold was not fully filled, shape of Example did not fully follow the geometry of the mold;
2: Mold was fully filled, shape of the Example followed that of the mold, visible fiber beneath the surface of the molded Example;
3: Mold was fully filled, shape of the Example followed that of the mold, Examples had smooth surface without visible fiber.

The result of measurement is presented in Table 2

TABLE 2
Measurement result of Examples

| | Flexural | Flexural | Impact | | | Fidelity |
|---|---|---|---|---|---|---|
| | strength | modulus | strength | HDT | FR | to mold |
| Example | MPa | MPa | KJ/m2 | ° C. | check | shape |
| EX1 | 141 | 8140 | 17 | 161 | Pass | 2 |
| EX2 | 165 | 11300 | 22 | 163 | Pass | 2 |
| EX3 | 144 | 8360 | 18 | 162 | Pass | 3 |
| EX4 | 145 | 8395 | 18 | 162 | Pass | 3 |
| EX5 | 138 | 7831 | 15 | 161 | Pass | 2 |
| EX6 | 160 | 10500 | 21 | 162 | Pass | 2 |
| EX7 | 141 | 8030 | 16 | 162 | Pass | 3 |
| EX8 | 141 | 8025 | 16 | 162 | Pass | 3 |
| EX9 | 132 | 7414 | 13.6 | 161 | Fall | 3 |
| EX10 | 141 | 7800 | 8.3 | 159 | Fall | 3 |
| EX11 | 180 | 7290 | 26 | 163 | Pass | 1 |

It is clear from Table 2 that EX9, 10, 11 not according to the invention did not have the required FR performance or fidelity to the mold shape. Among the inventive Examples EX1 to 8, EX3, 4, 7, 8 according to the preferred embodiment of the present invention had superior fidelity to the mold during the shaping.

1. An article comprising a first layer and a second layer,
wherein the first layer comprises a first polypropylene composition comprising a first polypropylene and dispersed glass fibers (A), wherein the dispersed glass fibers (A) have an average length in the range from 0.3 to 6.3 mm, wherein the amount of the dispersed glass fiber (A) is in the range from 14.7 to 67.2 wt % based on the total amount of the first polypropylene composition,
wherein the second layer comprise a second polypropylene composition comprising a second polypropylene and continuous glass fibers, wherein the continuous glass fibers are substantially parallel with each other, wherein the amount of the continuous glass fibers in the second polypropylene composition is in the range from 18.8 to 63.4 wt % % based on the total amount of the second polypropylene composition.

2. The article according to claim 1, wherein the first polypropylene composition comprises a first flame retardant composition, wherein the amount of the first flame retardant composition is in the range from 13.2 to 43.1 wt %, on the total amount of the first polypropylene composition.

3. The article according to claim 1, wherein the second polypropylene composition comprises a second flame retardant composition, wherein the amount of the second flame retardant composition is in the range from 12.2 to 32.1 wt %, based on the total amount of the second polypropylene composition.

4. The article according to claim 1 wherein the first layer has a thickness in the range from 0.6 to 2.4 mm.

5. The article according to claim 1 wherein the second layer has a thickness in the range from 0.3 to 3.2 mm.

6. The article according to claim 1 wherein the MFI of the first polypropylene is in the range from 23 to 85 g/10 min, as measure according to ISO1133 at 230° C., 2.16 kg.

7. The article according to claim 1 wherein the diameter of the dispersed glass fiber is in the range from 5 to 50 μm.

8. The article according to claim 1 wherein the average length of the dispersed glass fiber is in the range from 0.5 to 5.8 mm.

9. The article according to claim 1 wherein the second layer has an area density in the range from 1125 to 5600 g/m2.

10. The article according to claim 1 wherein the article further comprises a third layer, wherein the third layer comprise a third polypropylene composition comprising a third polypropylene and dispersed glass fibers (B), wherein the dispersed glass fibers (B) have an average length in the range from 0.3 to 6.3 mm, wherein the amount of the dispersed glass fiber (B) is in the range from 14.7 to 67.2 wt % based on the total amount of the first polypropylene composition,

11. The article according to claim 10, wherein second layer is between the first layer and the third layer.

12. The article according to claim 10, wherein the third layer is identical to the first layer.

13. The article according to claim 1 wherein the first layer has a UL94 rating of V0 and the second layer has a UL94 rating of V0.

14. Process for the preparation of an article according to claim 1 comprising the sequential steps:
providing the first layer and the second layer;
thermoforming the first layer and the second layer.

15. The article according to claim 1, wherein the article is part of a battery enclosure in a vehicle.
